(19) United States
(12) Patent Application Publication
(10) Pub. No.: US 2008/0179462 A1
(43) Pub. Date: Jul. 31, 2008

(54) Inflatable parasail jump suit combination

(76) Inventor: Peter J. Murphy, Roseville, CA (US)

Correspondence Address: Walt Froloff, 273D Searidge Rd, Aptos, CA, 95003, US

(21) Appl. No.: 11/699,277

(22) Filed: Jan. 29, 2007

(51) Int. Cl. B64D 17/02

(52) U.S. Cl. 244/143

(57) ABSTRACT

The present invention is a fast inflating parasail jump suit combining an inflatable parasail, an inflatable jump suit with outside and inside coupled at edges to provide an inflatable pressurized gas volume, at least one inflator device for storing and swiftly releasing pressurized gas into the parasail and suit upon activation, a suit harness coupling outside of suit to inside liner to body center of mass, and attachments coupling to parasail providing sail support to suit in suspension.

### BACKGROUND

### Field of the Invention

The present invention generally relates to an inflatable jump suit, for use in slowing decent from a height with small open spaces between building or as a recreation device. The present invention is well suited for use in emergency situations where individuals can become trapped in tall building with limited access to safety, save by jumping out of a building opening or building top.

Inflatable and non-inflatable parachutes have been available for some time. Some inflatable parachutes for use as escape or sporting device use a parachute canopy supported by an inflatable frame consisting of a network of inflatable lightweight flexible tubes. Bottled air or gas may be utilized to inflate the device through an inflation valve provided thereon. A restraining belt permits pre-inflation of the framework such that upon release the canopy expands almost instantaneously by the straightening of folded flexible tubes. While good in expansive open spaces away from building, this device may get caught up or entangled in the building across the street, introducing risk of dire consequences to the jumper. Moreover, control strings must be pulled and let go, structures must be avoided, etc, lending this type of arrangement to require the user to be trained in the art of jumping, something not everyone wants to do or should be required.

Other inventions offer seat harness for parachute of the type having a flexible wing allow the parachutist to a parachute with a flexible wing, controllable through modification of the shape of the aerodynamic surface plane by displacement of user center of gravity G. This invention requires skill and training to master, and many cannot or would not use this under emergency circumstances. Some horizontal support or seat attaching vertical straps or principal elevator for piloting. These provide a harness for the wing but also require flight and landing practice and skill, not something everybody wants to pursue.

Some devices provide aerial floating flier such as airfoil or a parachute is folded and contained in a case, and by throwing out such a case or an aerial floating flier in folded state into the air, the aerial floating flier is spread in the air, thereby allowing to escape from a site of an accident by hanging from the aerial floating flier and descend slowly on the ground. This has the same deficiencies as the above, necessity for skill, training, knowledge and practice.

What is needed is a device to slow decent from a height, one that requires a minimum of knowledge, skill, training and courage, and has some redundancy in the descent mechanisms for added safety.

Some building emergency escape devices disclose tube conduits into a water tank located at the bottom of the tube, and a parachute inside the tube for controlling the velocity of the descending person. By raising the water level above the tube exit, air is trapped between the water and the parachute, thereby providing the upward pressure on the parachute during the descent. While eminently doable, this method suffers an economic down side to the building owner, who must pay for an expensive escape device despite the fact that an emergency scenario may never arise.

Some decent slowing devices include accelerating the opening and/or extension for aviation devices, such as canopy parachutes, square or sliding parachutes, gliders, and other devices for accelerating the opening and/or the extension of aviation devices. Some designed air space form claim the a hose or an air-impervious hem which is under high air pressure in operative conditions, so that when the wrapper is opened this air space stretches out in a very short time and the aviation device opens after a fall of only 20-30 meters. These may employs a plurality of tubular of air chambers connected at their sides, these air chambers being typically open at their one end and closed at their other end and connected to a harness. These devices suffer from all of the deficiencies cited above, that skill is required, that the use may collide with a structure nearby during decent, not usable in tight small open space city situations.

Some wing design provide no framing to maintain its spanned out shape under the loading of flying lines by increased aerodynamic forces at wing tips achieved from making the aerofoil profiles of the cells progressively more reflexive towards wing tips, by giving wing tips a residual twist increasing their angle of incidence, by placing the centers of pressure of the cells near wing tips somewhat forward of the pivot line of the wing, etc. These require that the total payload weight is carried by the wing, forcing the wing to be much larger and less usable in tight open spaces between buildings. Inflating a large wing from ram air adds the risk of exceeding time allotted for initializing and stabilizing decent. Large wing structures also are more easily collapsible and during the worst possible times. What is needed is a smaller wing, shorter inflation time but less risk in decent into an adjacent building and landing velocities higher than bone cracking.

What is needed is device that reduces decent from a height with urban lateral clearances, providing a decent from a height that does not reach terminal velocities that will injure the jumper. Such escape suits should be affordable to tall building owners and occupiers, but not require training or skill from trapped occupants.

### SUMMARY

The present invention discloses an inflatable parasail jump suit combination complete with an inflatable parasail, an inflatable jump suit with outside and inside, at least one inflator device for storing and releasing pressurized gas into the parasail and suit upon activation, and attachments coupling suit to parasail providing sail support to suit upon suspension in air. Spiral trajectory collision avoidance and rotational cushioning at the bottom allows a user wearing suit to safely jump from a minimum height and be protected from a lethal impact, relying on parasail glide and lighter than air gas to slow decent, and conversion of vertical drop to rotational energy for impact reduction

### BRIEF DESCRIPTION OF DRAWINGS

FIG. 1 is an front view drawing of a parasail jump suit in accordance with an embodiment of the present invention.

FIG. 2 is an side view drawing of a parasail jump suit in accordance with an embodiment of the present invention.

FIG. 3 is an isometric drawing of a parasail jump suit in accordance with an embodiment of the present invention.

FIG. 4 is an isometric illustration of a parasail jump suit footing in accordance with an embodiment of the present invention

FIG. 5 is an illustration of suit's trajectory while in use from a height with proximate dwellings according to an embodiment of the present invention.

FIG. 6 is an illustration of a final approach of a user of a parasail jump suit in accordance with an embodiment of the present invention.

FIG. 7 is an illustration of a landing maneuver of a user of a parasail jump suit in accordance with an embodiment of the present invention.

### DETAILED DESCRIPTION

Specific embodiments of the invention will now be described in detail with reference to the accompanying figures.

In the following detailed description of embodiments of the invention, specific details are set forth in order to provide a more thorough understanding of the invention.

However, it will be apparent to one of ordinary skill in the art that the invention may be practiced without these specific details in lieu of substitutes. In other instances, well-known features have not been described in detail to avoid unnecessarily duplication and complication.

### OBJECTS AND ADVANTAGES

The present invention provides an escape apparatus, enabling an individual in time of crisis to escape an impending disaster while trapped at a dangerously elevated height. Such an individual can don the invention suit and take suit accessories, initiate the inflation of and throw themselves into free fall, thus escaping the impending disaster by descending to the ground at a rate which can be decelerated without harm to the jumper.

The present invention uses at least five mechanisms to slow descent, and decelerate jumper; lighter than air gas for buoyancy, small parasail to slow descent, bursting gas sub-compartments for deceleration of impact, advantageous use of inflatable advantage on ground for added padding, and rotational landing dynamics to translate vertical descent kinetic energy to inertial rotational kinetic energy for impact time dilation.

The detailed description is described in the figures and in the paragraphs following.

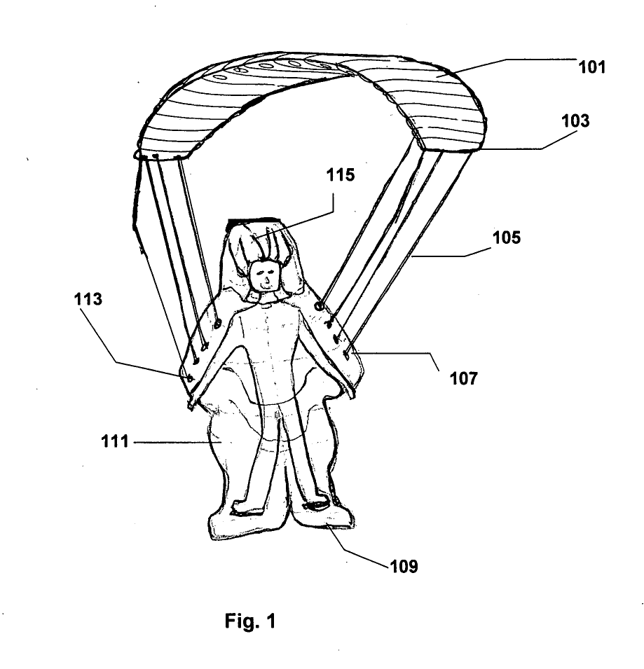

FIG. 1 is an front view drawing of a parasail jump suit in accordance with an embodiment of the present invention. Indicated elements of an inflatable parasail jump suit combination are the inflatable parasail 101, parasail attachment 103 point, strings or tube-like conduits 105 for coupling parasail to suit arm attachment 107 anchors, outer suit 111, suit inner lining 113, suit hood 115, and suit footing 109. These elements comprise parts of an embodiment which takes advantage of deceleration mechanisms for a individual in atmospheric free fall.

The parasail 101 provides descent support to the suit in suspension, slowing but not necessarily totally supplying all of the lift for slowing descent. The inflatable suit filled with lighter than air gas is expandable, made of material capable of some expansion or designed for sufficient volume to supply some buoyancy to the jumper, but not necessarily all of the buoyancy needed for reversing descent. The inner 113 and outer suit 111 need not be of the same material, as they have slightly different functions and weight, strength, density, stretch expandability etc will be factors in their design. whereby a user wearing suit can safely jump from a minimum height and be protected

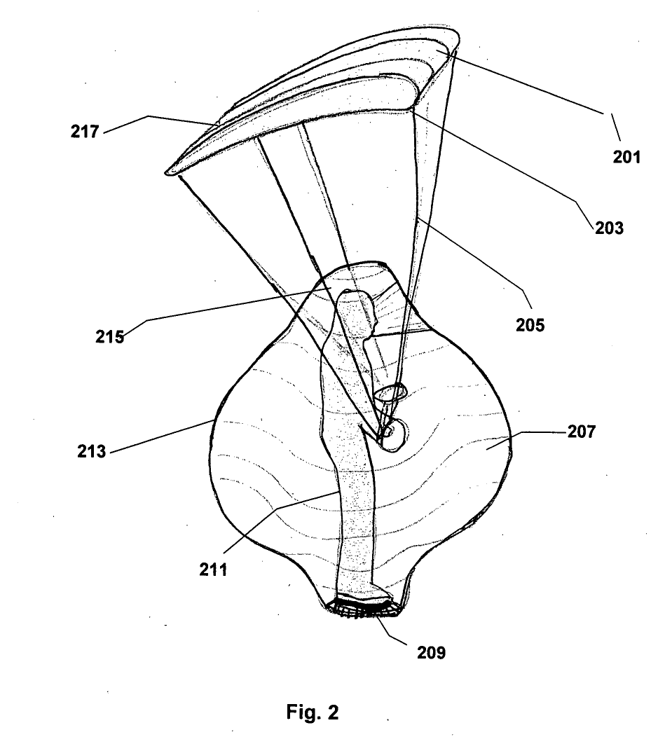

FIG. 2 is an side view drawing of a parasail jump suit in accordance with an embodiment of the present invention. The elements comprising the parasail and suit combination are shown as the parasail leading edge 201, parasail trailing edge 217, string or coupler attachment 203 points, string or conduit couplers 205, inner 211 and outer suits 213 walls, footer 209, inflatable hood 215, and bulge geometry 207. The inflatable bulge geometry 207 provides not only the capacity for a large volume of gas, but also for the cushion upon deceleration, dispersion of energy in rotation upon impact, buffer for structure impingement during descent, in the eventuality of large building densities and proximity of structures interfering with descent trajectory. In the case of collision with structures during descent, the bulge cushion character of the suit acts as a bounce buffer to reflect the trajectory away from and towards a path to further descend to ground or lower and safer elevation. Here an inflatable parasail does not collapse, but changes direction to recover and maintain lift as soon as air flow is resumed and maintaining its shape by inflation thereby instantaneously becoming the wing in an altered direction Friction from a mid-air collision is used advantageously impart momentum to the structure, to further slow descent and provide yet another mechanism slowing descent. The parasail may have more then one compartment, to make up more buoyancy from gas, better foil aerodynamics for sail foil shaping, or more cushion upon impact, providing inflation speed characteristics and impact mitigation similar to a auto airbag.

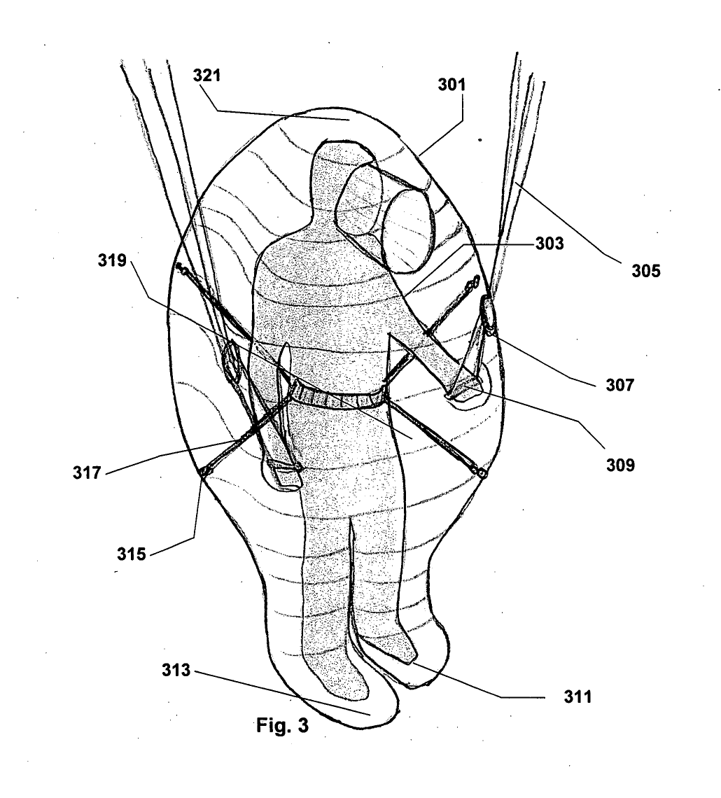

FIG. 3 is an isometric drawing of a parasail jump suit in accordance with an embodiment of the present invention. The suit outside 301 can be most any light but inflatable material and coupled to an inside 303 lining, conformably pressured against the user. The outer 301 side is not drawn to scale, and may be much larger than illustrated in the figures. The material of the outer 301 suit and inner lining 303 may be different, but both will be as low weight as allowable and air tight coupled together. The outer 301 suit may need undergo some expansion or stretch, while the inner 303 lining will not necessarily stretch very much. These materials are know to those skilled in the art. The outer 301 suit will sustain more tensile forces, from landing impact and internal gas pressure stresses. The geometry of the outer suit as illustrated is bulgy 319 and circular in the forward direction, for the reason that collisions will need more deceleration time and hence more cushion effect. The somewhat thinner sides 307 allow for steering, grasping and all around balancing of the suit before and during the jump. A pocket opening in the suit side 307 is provided for the hand control 309 mechanism for arm length use of hands. The hand controler may be a simple bar or a sophisticated electronic mechanism for automatic steering, opening, and landing sequence manipulation. The parasail attachment lines 305 will attach to the hand control 309. The inner 303 lining will integrate a harness belt 315 with attachments 317 to the outer 301 suit at reinforced attachment supports 315. The feet 313 will have separate leg extensions 311 for ambling to a ledge or building side. The suit head 321 will be contoured to round out the suit 301 for protection in rotation and bouncing upon landing impact. Not shown is an inflator device, which can be external or internal to the suit.

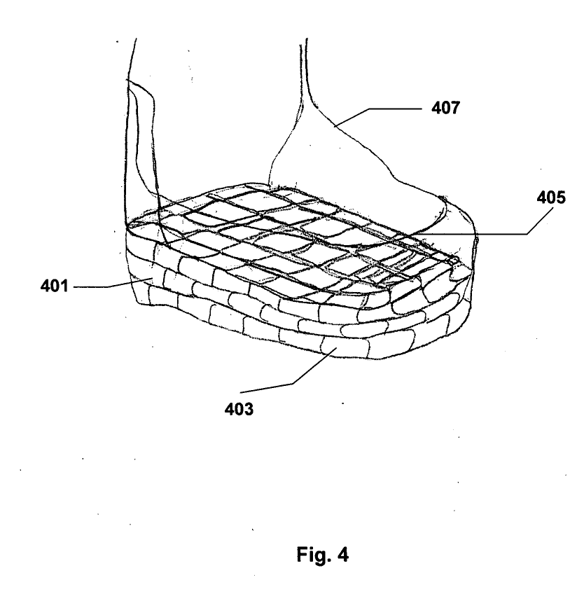

FIG. 4 is an isometric view of a parasail jump suit footing in accordance with an embodiment of the present invention. Cells 401 of gas sub compartments are layered 403 in a fashion shown as shoe soles. These cells 401, plurality of adjacent one-way pressurized gas or vapor sub-volume compartments capable of gas energy absorption upon compression can have one-way gas valves or membranes that allow compressed gas to enter quickly but not leave quickly. Releasing the pressurized gas would dissipate energy from collision. These layered cells are securely coupled to the suit footing 405 and can be inside or outside of the suit 407, depending in the gas pressurization device and location. The object of the cell 401 sub compartment are much like those in plastic packing material, which deform and absorb energy which is released thru rupturing. In doing so, multiple layers 403 of these cells will decelerate the jumper and mitigate the impact force over a larger time interval and spatial area. A gas inflator device, not shown, can be stored near the footing as well, providing addition energy absorption from crumpling on impact.

The cells 401 and layers 403 can be of most any light and gas internally pressurizable material, capable of deformation from external pressure and rupture at a design pressure. Only three layers 403 are shown but more can be added. The top layer will have a plate structure which integrates the ruptures of the group of cells and distributes the pressure over time of rupturing and area above all the cells.

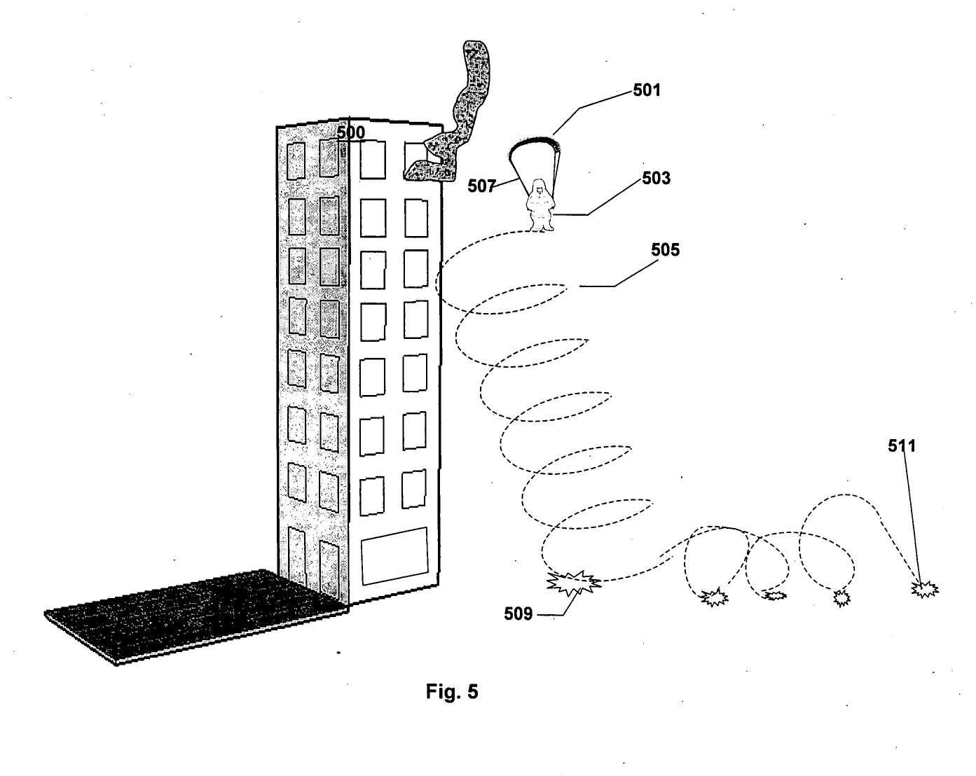

FIG. 5 is an illustration of suit's trajectory while in use from a height with proximate dwellings according to an embodiment of the present invention. A jumper 503 is shown to have availed himself of a jumper parasail suit 503 and stepped off a building 500 which is presumably disallowed other forms of escape. The parasail 501 is inflated immediately and the coupling 507 attaching the parasail 501 to the suit 503 can be inflated from a common inflator device, pressurizing with a lighter than air gas such as helium or hydrogen or mixture, forcing the gas thru the attachment tubs 507. Alternatively, separate compressed gas inflators can reside in the parasail and in the suit. The attachment strings 507 or tubes 507 are foreshortened on one side or the other, forcing the descent trajectory 505 to spiral downward. This is so that collisions with nearby structures are avoided. In the event that a mid trajectory collision is incurred, the suite 503 and inflated parasail 501 will bounce off and continue in a reflected direction, in a somewhat changed trajectory but continuing to slow descent. Upon reaching the bottom 509, the jumper will have vertical and circular component terminal velocities. The vertical terminal velocity will be damped on impact 509 but continue to dissipate the fall energy by transfer into rotational inertial energy which will be eventually damp out from deformable collisions and motion will come to a halt 511.

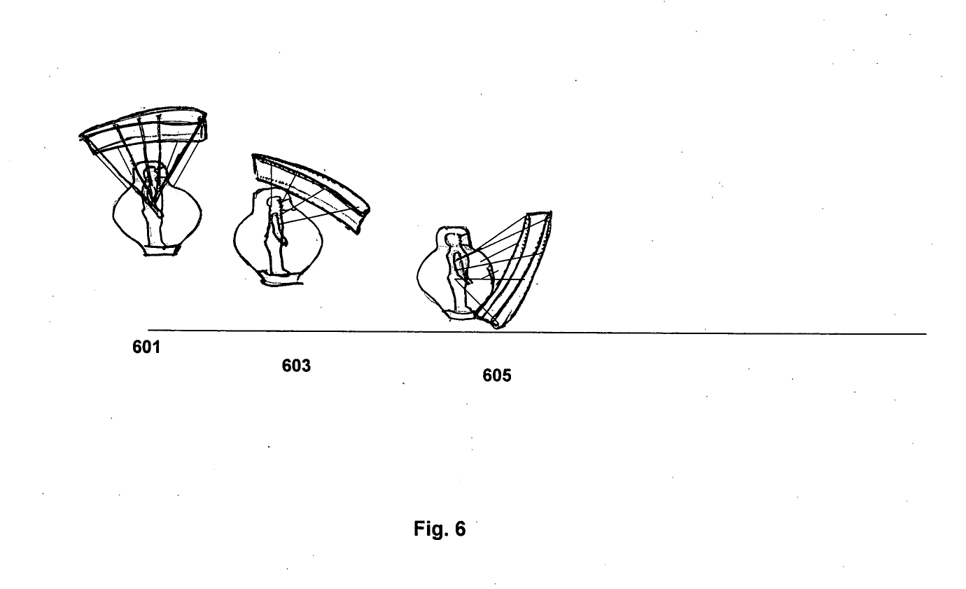

FIG. 6 is an illustration of a final approach of a jumper in accordance with an embodiment of the present invention. As the jumper approache the landing 601, the parasail will need to move forward 603 as it will provide additional cushion upon impact. The timing of the touchdown 605 and the parasail position must be synchronized in such a fashion as to find the parasail directly in front of 605 and approaching below the jumper. Thus as jumpers footing absorbs some energy, the forward motion component will act to put the vertical component into rotational energy, wherein the inflated suit with the inflated parasail act as cushions in damping and dispersing energy in compression and rotation until the motion is completely damped and the jumper comes to a halt.

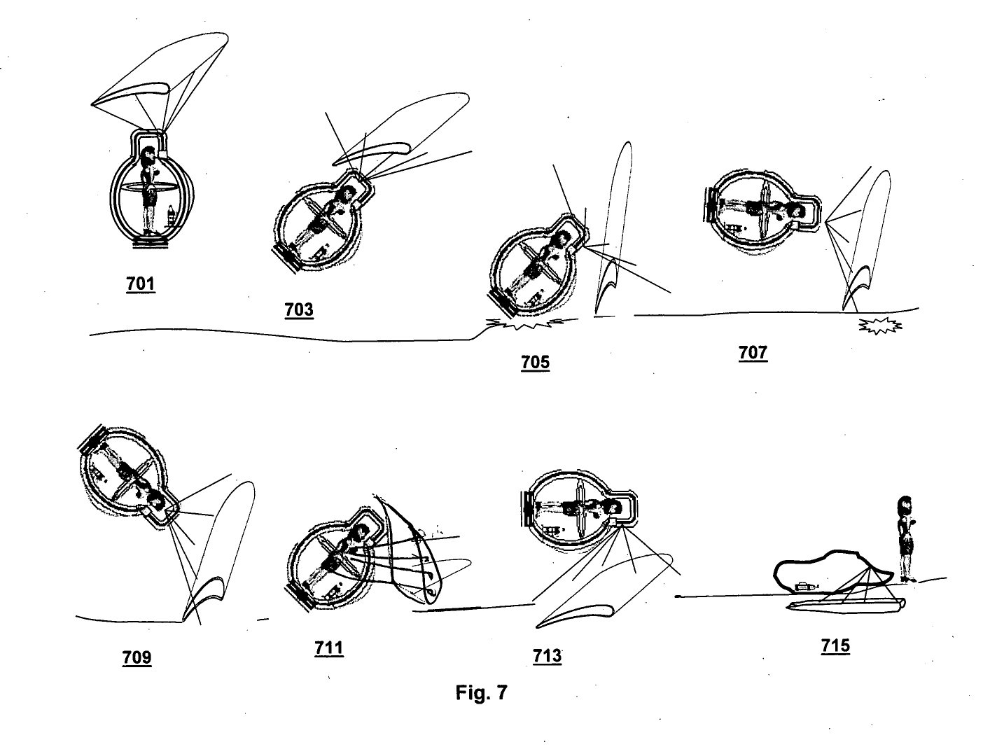

FIG. 7 is an illustration of a landing maneuver of a user of a parasail jump suit in accordance with an embodiment of the present invention. Upon final approach 701 703 the jumper will maneuver the parasail to cushion the impact 705. The impact with ground will be an elastic and deformable, but will impart a spring force 707 pushing the jumper into a rotational dynamic, from the compressed inflatable cushioning spring affect and the terminal velocity components applying overturning moments to the jumper. The jumper will continue to bounce 709 and roll 711 entangled with the inflated parasail 713 until collisions have been damped out 715.

Therefore, while the invention has been described with respect to a limited number of embodiments, those skilled in the art, having benefit of this invention, will appreciate that other embodiments can be devised which do not depart from the scope of the invention as disclosed herein. Accordingly, the scope of the invention should be limited only by the attached claims. Other aspects of the invention will be apparent from the following description and the appended claims.

What is claimed is:

1. A fast inflating parasail jump suit combination comprising:
an inflatable parasail;
an inflatable jump suit with outside and inside coupled at edges to provide an inflatable gas volume,
at least one inflator device for storing and releasing pressurized gas into the parasail and suit upon activation,
a suit harness and attachments coupling to parasail providing sail support to suit in suspension;
whereby a user wearing suit can safely jump from a minimum height and be protected from a lethal impact, relying on parasail glide and lighter than air gas to slow decent, and conversion of vertical drop to rotational energy for impact reduction.

2. An inflatable parasail jump suit as in claim 1 further comprising tubular attachments for filling parasail with gas from inflator device located on suit.

3. An inflatable parasail jump suit as in claim 1 further comprising a parasail filled with gas from inflator device located on parasail.

4. An inflatable parasail jump suit as in claim 1 further comprising a parasail with two parallel adjacent compartments.

5. An inflatable parasail jump suit as in claim 1 further comprising automatically adjustable attachments allowing shortening from either side of suit to produce a circular descent trajectory.

6. An inflatable parasail jump suit as in claim 1 further comprising gas inflator of light weight construction material.

7. An inflatable parasail jump suit as in claim 1 further comprising suit inside of different material than suit outside

8. An inflatable parasail jump suit as in claim 1 further comprising suit foot bottoms with a plurality of adjacent one-way pressurized gas or vapor sub-volume compartments capable of gas energy absorption upon compression.

9. An inflatable parasail jump suit as in claim 1 further comprising parasail attachments which can manually or automatically move the parasail into close suit proximity upon impact with trajectory target destination.

10. An inflatable parasail jump suit as in claim 1 further comprising gas inflator for storing and swift releasing lighter-than-air pressurized gas.

11. An inflatable parasail jump suit as in claim 1 further comprising a harness coupling the inside and outside of suit whereby an outside wall deformation drives pressurized gas to the opposite suit side applying a collision countering force to the harness opposite to the deforming outside suit wall tending to move the harness attached center of mass opposite the collision direction.

12. An inflatable parasail jump suit as in claim 1 further comprising separate volume compartments in the suite, whereby deformation of some compartments may produce compression pressures not transferred to other compartments.

13. An inflatable parasail jump suit as in claim 1 further comprising at least one internal or external inflator device.
